(19) United States
(12) Patent Application Publication
(10) Pub. No.: US 2004/0016537 A1
(43) Pub. Date: Jan. 29, 2004

(54) Automotive air-conditioner having aspirator for temperature sensor

(76) Inventors: Takeshi Nakamura, Anjo-city (JP); Toshihiro Tahara, Nagoya-city (JP); Takahiro Tokunaga, Kosai-city (JP)

Correspondence Address: HARNESS, DICKEY & PIERCE, P.L.C., P.O. BOX 828, BLOOMFIELD HILLS, MI, 48303, US

(21) Appl. No.: 10/627,111

(22) Filed: Jul. 25, 2003

(30) Foreign Application Priority Data
Jul. 26, 2002 (JP) 2002-217888

(51) Int. Cl. B60H 1/00; B60H 1/32; F25B 29/00; F25D 17/04

(52) U.S. Cl. 165/204; 62/244; 62/186; 62/159

(57) ABSTRACT

Air is introduced into an automotive air-conditioner from a front side of a vehicle, and the air conditioned in the air-conditioner is supplied to a passenger compartment from a rear side of an air-conditioner casing. An aspirator for drawing air in the passenger compartment to a temperature sensor is mounted on a rear wall or a sidewall of the casing, so that the aspirator is exposed to a space that is always communicating with the conditioned air in the air-conditioner. In this manner, the air in the passenger compartment is surely supplied to the temperature sensor irrespective of operating modes of the air-conditioner.

### CROSS-REFERENCE TO RELATED APPLICATION

This application is based upon and claims benefit of priority of Japanese Patent Application No. 2002-217888 filed on Jul. 26, 2002, the content of which is incorporated herein by reference.

### BACKGROUND OF THE INVENTION

1. Field of the Invention

The present invention relates to an air-conditioner for use in an automotive vehicle, the air-conditioner including an aspirator for supplying air to a sensor measuring temperature in a passenger compartment.

2. Description of Related Art

In a conventional automotive air-conditioner, air in a passenger compartment is supplied to a temperature sensor through an aspirator. Air blown out of a blower is introduced into a venturi portion of the aspirator to decrease pressure therein, and air in the passenger compartment is sucked into the venturi portion of the aspirator through the temperature sensor. In this manner, the air in the passenger compartment is supplied to the temperature sensor.

A so-called center-positioned air-conditioner, which is positioned substantially at a width-center of a vehicle width (at a center between a right side and a left side of a vehicle) and inside of an instrument panel, has become popular because it can be conveniently mounted on the vehicle. An example of a conventional center-positioned air-conditioner is shown in FIG. 13. An air passage is formed in an air-conditioner casing 11 so that air flows from a front side of the vehicle to a rear side. In the air passage, an evaporator 12 for cooling and a heater core 13 for heating are disposed. A portion of air cooled by the evaporator 12 flows through a bypass passage 15, and the other portion of cooled air flows through the heater core 13 to be heated. An amount of air flowing through the bypass passage 15 is controlled by an air-mixing door 16. The cooled air and the heated air are mixed in an air-mixing space 20 to obtain air controlled at a desired temperature.

At a rear side of the air mixing space 20, a face opening 23, a foot duct 24 and foot openings 27, 28 are disposed. Air flowing through the face opening 23 and air flowing through the foot duct 24 are switched by a face-foot switching door 25. On the other hand, the aspirator for the temperature sensor has to be positioned in the air-conditioner casing 11, so that air in a passenger compartment is always supplied properly to the temperature sensor irrespective of operating modes of the air-conditioner.

In the center-positioned air-conditioner, the conditioned air does not flow through the foot duct 24 when the air-conditioner is operated under a face mode or a defroster mode, because the conditioned air is blown out of the face opening 23 under the face mode and out of a defroster opening 21 under the defroster mode. Therefore, it is not proper to mount the aspirator on a rear wall 32 of the air-conditioner casing 11. In the conventional center-positioned air-conditioner, the aspirator is usually mounted on a sidewall, which extends from the front side to the rear side of the vehicle, at such a position A1 or A2 as illustrated in FIG. 13. The conditioned air can be always introduced into the aspirator from the air-mixing space 20 irrespective of operating modes if the aspirator is positioned at A1 or A2. In addition, a conditioned environment in the passenger compartment is not adversely affected by the air blown out of the aspirator because the air blown out of the aspirator is the conditioned air.

In the conventional center-positioned air-conditioner, however, the aspirator can be properly positioned only at a limited area in the air-conditioner casing 11. In other words, there is only a limited freedom in selecting mounting positions of the aspirator. Further, the area around the air-mixing space 20 where the aspirator is properly positioned is crowded with a temperature-control mechanism for controlling the air-mixing door 16 and devices for operating the defroster door 22 and the face-foot switching door 25. Therefore, it is very difficult to select a proper space for positioning the aspirator. In addition, since the aspirator has to be positioned close to servomotors for the temperature-control mechanism and for controlling doors 22, 25, the cool air that is blown out of the aspirator when the air-conditioner is operating in a cooling mode is directed to the servomotors. Due to the cool air blown to the servomotors, moisture in the servomotors may be condensed and may cause damages therein.

JP-U-57-177812 discloses an air-conditioner in which an aspirator is mounted on a rear wall of an air-conditioner casing. However, the air-conditioner disclosed therein is a so-called laterally positioned air-conditioner, in which a blower unit, a cooler unit including an evaporator and a heater unit are laterally poisoned along a lateral direction of a vehicle. It is possible to mount the aspirator on the rear wall of the air-conditioner casing in this type of the air-conditioner. However, the laterally positioned air-conditioner requires much space in the lateral direction of the vehicle. Therefore, the center-positioned air-conditioner is now popular in the market.

### SUMMARY OF THE INVENTION

The present invention has been made in view of the above-mentioned problem, and an object of the present invention is to provide an improved center-positioned air conditioner, in which mounting positions of an aspirator can be selected with a greater freedom.

In a so-called center-positioned air-conditioner, air is introduced into an air-conditioner casing from a front side of the vehicle. Air conditioned in the casing is blown out to a passenger compartment form a rear side of the casing. More particularly, the air introduced into the air-conditioner casing is first cooled by an evaporator. Then, a portion of the cool air is supplied to a heater core to be heated again, while the other portion of the cool air flows through a bypass passage. A ratio of the cool air flowing through the bypass passage to the cool air supplied to the heater core is controlled by an air-mixing door disposed in the bypass passage. By controlling positions of the air-mixing door, the conditioned air is controlled to a desired temperature.

The cool air directly supplied from the evaporator and the heated air passing through the heater core are mixed in an air-mixing space. Then, the mixed air is blown to the passenger compartment through either a face opening or a foot opening, or through both openings. The conditioned air (mostly cool air) blown out of the face opening is supplied to an upper portion of passengers, while the conditioned air (mostly hot air) blown out of the foot door is supplied to a lower portion of passengers. A mode under which the conditioned air is blown out of the face opening is called a face mode, a mode under which the conditioned air is blown out of the foot opening is called a foot mode, and a mode under which the conditioned air is blown out of both openings is called a bilevel mode. A mode-control mechanism mounted on the air-conditioner casing sets the air-conditioner operation to a mode selected by the passenger.

Temperature in the passenger compartment has to be always correctly measured by a temperature sensor in order to keep the conditioned air at a desired temperature. To draw air in the passenger compartment to the temperature sensor, an aspirator is attached to the temperature sensor. Air in the air-conditioner has to be always blown to the aspirator irrespective of the operation modes to effectively draw the air in the compartment to the temperature sensor.

A foot duct for leading the conditioned air to the foot opening is provided at a rear portion of the casing, and the aspirator is mounted on a rear wall so that it is exposed to the foot duct. The conditioned air is always led into the foot duct even when the face opening is fully opened and the foot opening is closed. Therefore, the air is always blown to the aspirator irrespective of operating modes of the air-conditioner. The aspirator may be mounted on a sidewall of the casing as long as the aspirator always communicates with a space in the foot duct. Alternatively, the foot duct may be eliminated, and the foot opening may be formed on the sidewall. In this case the aspirator is installed on the rear wall or the sidewall, so that the aspirator is exposed to a space that is always communicating with the air-mixing space irrespective of the operating modes.

According to the present invention, the aspirator can be mounted on the rear wall or the rear portion of the sidewall of the air-conditioner casing. In other words, mounting positions of the aspirator can be selected with a greater freedom without interfering with other control mechanisms of the air-conditioner. Other objects and features of the present invention will become more readily apparent from a better understanding of the preferred embodiments described below with reference to the following drawings.

### BRIEF DESCRIPTION OF THE DRAWINGS

FIG. 1 is a cross-sectional view showing an air-conditioner unit as a first embodiment of the present invention;

FIG. 2 is a cross-sectional view showing an aspirator mounted on the air-conditioner unit;

FIG. 3 is a cross-sectional view showing the air-conditioner unit which is in operation under a face mode;

FIG. 4 is a cross-sectional view showing the air-conditioner unit which is in operation under a foot mode;

FIG. 5 is a cross-sectional view showing the air-conditioner unit which is in operation under a defroster mode;

FIG. 6 is a cross-sectional view showing an air-conditioner unit as a second embodiment of the present invention;

FIG. 7 is a front view showing the air-conditioner unit shown in FIG. 6, viewed from a passenger compartment side;

FIG. 8 is a cross-sectional view showing the air-conditioner unit shown in FIG. 6, which is operating under a face mode;

FIG. 9 is a cross-sectional view showing the air-conditioner unit shown in FIG. 6, which operating under a bilevel mode;

FIG. 10 is a cross-sectional view showing the air-conditioner unit shown in FIG. 6, which is operating under a foot mode;

FIG. 11 is a cross-sectional view showing the air-conditioner unit shown in FIG. 6, which operating under a defroster mode;

FIG. 12 is a cross-sectional view showing an air-conditioner unit as a third embodiment of the present invention; and

FIG. 13 is a cross-sectional view showing a conventional air conditioner unit.

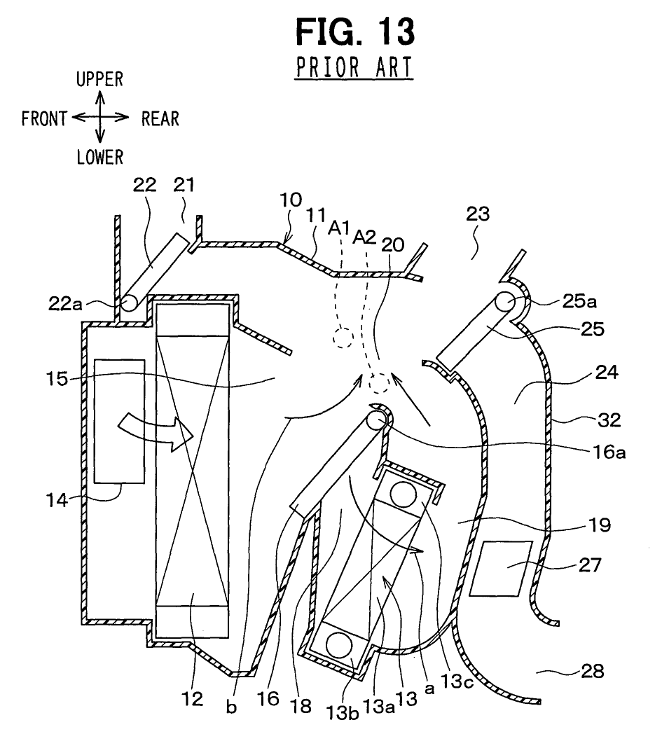

### DETAILED DESCRIPTION OF THE PREFERRED EMBODIMENTS

(First Embodiment)

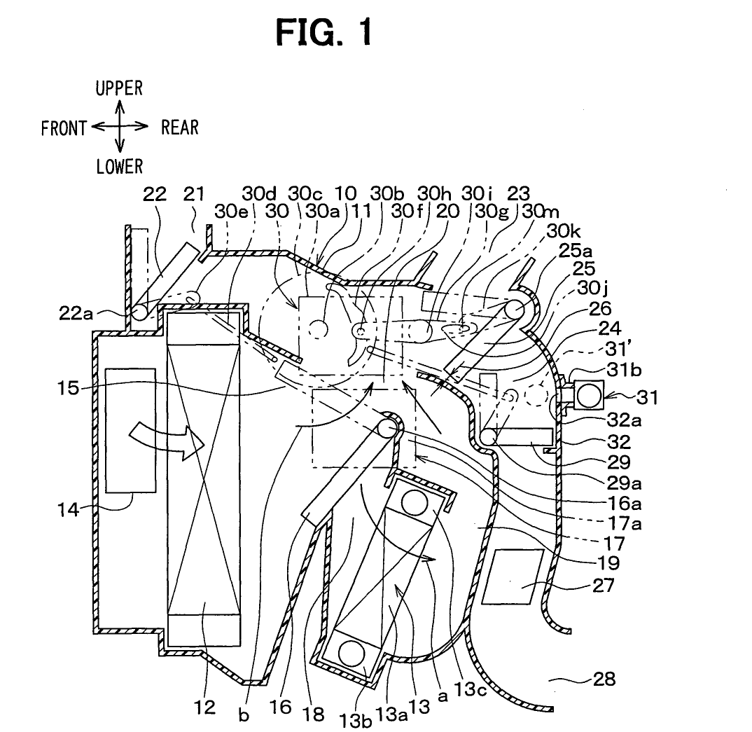

A first embodiment of the present invention will be described with reference to FIGS. 1-5. An air-conditioner for use in an automotive vehicle is composed of a blower unit (not shown) and an air-conditioner unit 10 shown in FIG. 1. The blower unit sends air to the air-conditioner unit 10, and the air-conditioner unit 10 conditions the air sent from the blower unit. The air-conditioner unit 10 is disposed inside an instrument panel and positioned substantially at a width-center of the vehicle (at a center portion between a right side and a left side of the vehicle).

The mounting directions of the air-conditioner unit 10 are shown in FIG. 1 and other drawings with crossing bars showing a front side, a rear side, an upper side and a lower side of the vehicle. The blower unit is positioned inside the instrument panel at a position offset from the center of the vehicle toward an assistant seat. The blower unit includes a box for switching outside air and inside air, and a centrifugal blower for supplying air to the air-conditioner unit 10.

Components of the air-conditioner unit 10 are all contained in an air-conditioner casing 11, and an air passage leading air from the front side of the vehicle to the rear side of the vehicle is formed in the air-conditioner casing 11. The air-conditioner casing 11 is composed of a pair of cases, a right side case and a left side case, connected together at the center portion of the air-conditioner casing 11. An evaporator 12 for cooling and a heater core 13 for heating are contained in the air-conditioner casing 11.

An air inlet 14 is formed in the casing 11 at its front position. Air blown out of the blower unit flows into the casing 11 through the air inlet 14. The evaporator 12 for cooling air by evaporating compressed refrigerant therein in a well-known manner is positioned downstream of the air inlet 14. A heater core 13 is disposed downstream of the evaporator 12 with a certain space apart therefrom. The air supplied from the air inlet 14 flows through the evaporator 12 and the heater core 13 in this order.

The heater core 13 is composed of a pair of header tanks 13b, 13c and a heat exchanger core 13a connected between the pair of header tanks 13b, 13c. The heat exchanger core 13a is a known type, including elongate tubes and corrugated fins disposed between the tubes. Hot water is supplied to the heater core 13 form a water jacket of an internal combustion engine. The heater core 13 is disposed in the casing 11 substantially at an upright posture with a small slanted angle as shown in FIG. 1. The air cooled through the evaporator 12 is supplied to the heater core 13 that heats the air again.

A bypass passage 15 is formed above the heater core 13. The air cooled by the evaporator 12 flows through the bypass passage 15, bypassing the heater core 13. An air-mixing door 16 is disposed at a lower portion of the bypass passage 15 between the evaporator 12 and the heater core 13. The air-mixing door 16 made of a flat plate is supported by a shaft 16a which is rotatably supported on both sidewalls of the casing 11. The sidewalls extend in the direction from the front side to the rear side of the vehicle and positioned substantially perpendicularly to a rear wall 32 that extends in the left to right direction of the vehicle. A temperature control mechanism 17 including a servomotor 17a is mounted on one of the sidewalls. One end of the shaft 16a is connected to the servomotor 17a so that the air-mixing door 16 is opened or closed in a controlled manner. The shaft 16a may be directly connected to the servomotor 17a or may be connected through a link mechanism.

The air-mixing door 16 controls an opening degree of an inlet passage 18 to the heater core 13. In other words, a ratio between an amount of cool air “b” flowing through the bypass passage 15 and an amount of hot air “a” flowing through the heater core 13 is controlled by the air-mixing door 16. A position of the air-mixing door 16 shown with a solid line in FIG. 1 is a position fully closing the inlet passage 18 and fully opening the bypass passage 15. This position is referred to as an opening degree 0%, corresponding to a maximum cooling position. On the other hand, a position of the air-mixing door 16 shown with a chained line in FIG. 1 is a position fully closing the bypass passage 15 and fully opening the inlet passage 18. This position is referred to as an opening degree 100%, corresponding to a maximum heating position. The air-mixing door 16 is controlled to arbitrary positions between the opening degree 0% and the opening degree 100%, thereby attaining a desired temperature by mixing the cool air “b” and the hot air “a”.

A hot air duct 19 is formed behind the heater core 13. The air heated by the heater core 13 flows through the hot air duct 19 and mixed with the cool air flowing through the bypass passage 15 at an air mixing space 20. A defroster opening 21 is disposed at an upper front portion of the casing 11. Conditioned air mixed in the air-mixing area 20 is supplied to the defroster opening 21 that is connected to a defroster outlet through a defroster duct (not shown). The conditioned air (mostly hot air) is blown to a windshield from the defroster outlet. The defroster opening 21 is opened or closed by a defroster door 22 that is supported by a rotatable shaft 22a.

A face opening 23 is disposed at an upper rear portion of the casing 11. The face opening 23 is connected to a face outlet located above an instrument panel through a face duct (not shown). The conditioned air (mostly cool air) is blown to an upper portion of a passenger from the face outlet.

A foot duct 24 is disposed substantially vertically in the rear portion of the casing 11. The foot duct 24 is connected to the face opening 23, and a face-foot switching door 25 is disposed above the foot duct 24. The face opening 23 and the foot duct 24 are selectively opened or closed by the face-foot switching door 25. The face-foot switching door 25 is made of a flat plate and supported by a rotatable shaft 25a. The position of the face-foot switching door 25 shown with a solid line in FIG. 1 is a position to fully open the face opening 23 and to close the food duct 24 (a face mode position). The face-foot switching door 25 at this face mode position does not completely close the foot duct 24, but there is a small opening 26 is formed between the face-foot switching door 25 and an inside wall of the casing 11 as shown in FIG. 1.

A foot opening 27 (for a front seat) is formed on each of the sidewalls connected to the foot duct 24, and a foot opening 28 (for a rear seat) is formed at a downstream end of the foot duct 24. The foot opening 28 is connected to a foot outlet for a rear seat through a foot passage (not shown). The conditioned air (mostly hot air) is blown to a foot portion of passengers from the foot outlets. A foot door 29 is disposed in the foot duct 24 downstream of the face-foot switching door 25 and upstream of the foot openings 27, 28. The foot door 29 is made of a flat plate and supported by a rotatable shaft 29a. The foot openings 27, 28 are opened or closed by the foot door 29.

The defroster door 22, the face-foot switching door 25 and the foot door 29 are doors for setting operation modes of the air-conditioner, and they are all controlled by a common mode-control mechanism 30 in an interrelated manner. The mode-control mechanism 30 is a driving mechanism including a servomotor 30a and is disposed on one of the sidewalls of the casing 11.

The mode-control mechanism 30 includes a disc-shaped driving plate 30c which is connected to an output shaft 30b of the servomotor 30a.One end of a connecting rod 30d is rotatably connected to a pin disposed on a point close to an outer periphery of the disc-shaped driving plate 30c. The other end of the connecting rod 30d is rotatably connected to a driving lever 30e for driving the defroster door 22. The driving lever 30e is integrally connected to the rotatable shaft 22a of the defroster door 22. The defroster door 22 is driven by the disc-shaped driving plate 30c to thereby open or close the defroster opening 21.

The disc-shaped driving plate 30c includes a groove 30f in which a pin 30h fixed to one end of a link 30g is slidably connected. The link 30g is rotatable around a shaft 30i, and a groove 30j is formed at the other end of the link 30g. A pin 30m connected to one end of a driving lever 30k is slidably disposed in the groove 30j. The driving lever 30k is fixedly connected to the rotatable shaft 25a supporting the face-foot switching door 25. The face-foot switching door 25 is driven by the driving plate 30c via the link 30g and the driving lever 30k.

Now, an aspirator 31 mounted on the rear wall 32 of the casing 11 will be described. The rear wall 32 extends in the right to left direction (the lateral direction) of the vehicle between both sidewalls. The aspirator 31 can be mounted on the rear wall 32 at any lateral position.

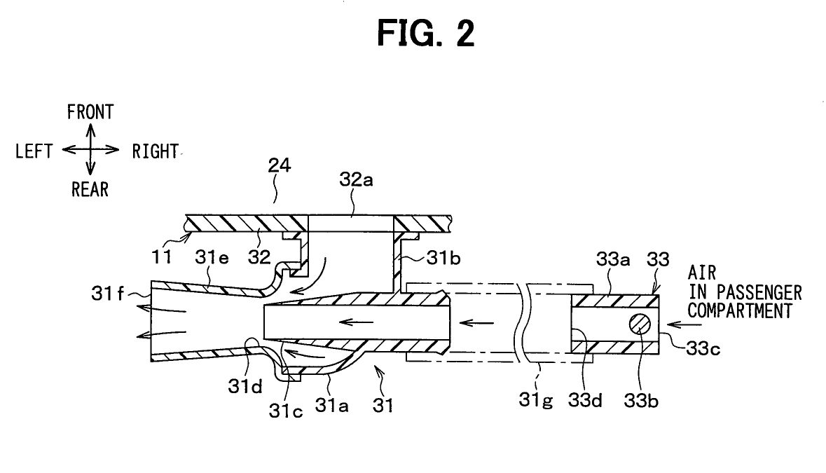

A structure of the aspirator 31 will be described in detail with reference to FIG. 2. The aspirator 31 is composed of a main housing 31a and an auxiliary housing 31e hermetically connected to the main housing 31a, both made of a resin material. The main housing 31a includes a nozzle 31c and an inlet pipe 31b connected to an air-introducing port 32a formed on the rear wall 32. The inlet pipe 31b of the aspirator 31 communicates with the foot duct 24 at a position between the face-foot switching door 25 and the foot door 29.

The auxiliary housing 31e includes a venturi portion 31d and an enlarged outlet 31f. The nozzle 31c of the main housing 31a is open to a center of the venturi portion 31d, and the outlet 31f is open to the passenger compartment at an inside of the instrument panel. The nozzle 31c is cylinder-shaped, and its inlet is connected to a temperature sensor 33 through a connecting pipe 31g.

The temperature sensor 33 is composed of a box-shaped case 33a and a sensor element 33b such as a thermistor disposed in the case 33a. Air inside the passenger compartment is introduced into the temperature sensor 33 from an inlet port 33c, and an outlet port 33d is connected to the nozzle 31c of the aspirator 31 through the connecting pipe 31g. The temperature sensor 33 is mounted inside the instrument panel at a substantially lateral center of the vehicle. Since the air-conditioner casing 11 is also disposed at the lateral center of the vehicle, a length of the connecting pipe 31g can be relatively short.

Operation of the air-conditioner described above will be explained below. Air blown out of the blower unit flows into the air inlet 14 of the air-conditioner unit 10. When the refrigeration cycle is in operation, the air flowing into the air-conditioner casing 11 is cooled down and dehumidified by the evaporator 12. If the air-mixing door 16 is driven to its intermediate position, a portion of the cool air flows into the inlet passage 18 of the heater core 13 as shown with an arrow “a” in FIG. 1 and is heated through the heater core 13. The heated air by the heater core 13 flows through the hot air duct 19 and reaches the air-mixing space 20. On the other hand, another portion of the cooled air flows through the bypass passage 15 as shown with an arrow “b” and also reaches the air-mixing space 20. The hot air and the cool air are mixed in the air-mixing space 20, and thereby conditioned air at a desired temperature is obtained. The conditioned air is supplied to the passenger compartment through a selected opening or openings 21, 23, 27, 28. The openings from which the conditioned air is blown out are determined according to desired operating modes.

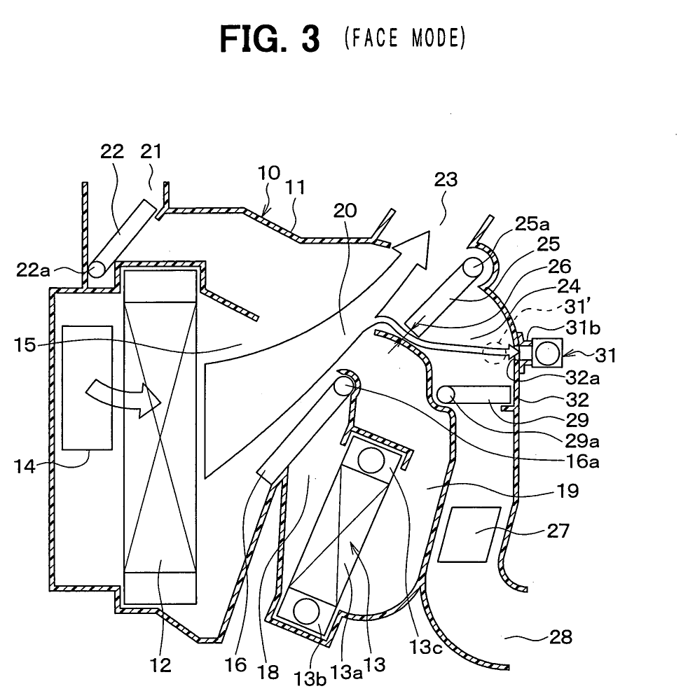

The operation of the air-conditioner under selected modes will be described with reference to FIGS. 3, 4 and 5. First, referring to FIG. 3, operation of the air-conditioner under the face mode will be explained. In FIG. 3, the air-mixing door 16 is brought to a position to fully close the inlet passage 18 and to fully open the bypass passage 15, i.e., the maximum cooling position. In a conventional air-conditioner, the face opening 23 is fully opened and the inlet to the foot duct 24 is fully closed under the face mode. In this embodiment, however, the inlet to the foot duct 24 is not fully closed but is partially opened under the face mode. In other words, the small opening 26 is provided at the inlet of the foot duct 24. The foot door 29 in the foot duct 24 is fully closed under the face mode, so that no air is supplied to the foot openings 27, 28. Also, the defroster opening 21 is fully closed by the defroster door 22.

Under the face mode, the cool air cooled by the evaporator 12 flows through the bypass passage 15 and the air-mixing space 20. A most portion of the cool air is blown out of the face opening 23 and supplied to the upper portion of the passengers. At the same time, a small portion of the cool air flows into the foot duct 24 through the small opening 26, and enters into the aspirator 31 through its air-introducing port 32a. The air introduced into the aspirator 31 flows through the venturi portion 31d and is blown out into the passenger compartment through the outlet 31f. When the air introduced into the aspirator 31 flows through the venturi portion 31d, pressure drop occurs because the flow speed of the air increases in the venturi portion 31d. Therefore, the air in the passenger compartment is drawn into the aspirator 31, and thereby the air in the passenger compartment is surely supplied to the temperature sensor 33. Thus, the temperature in the passenger compartment is sensed by the sensor element 33b without fail. The sensed temperature in the passenger compartment is used for calculating a target temperature of the air blown into the passenger compartment.

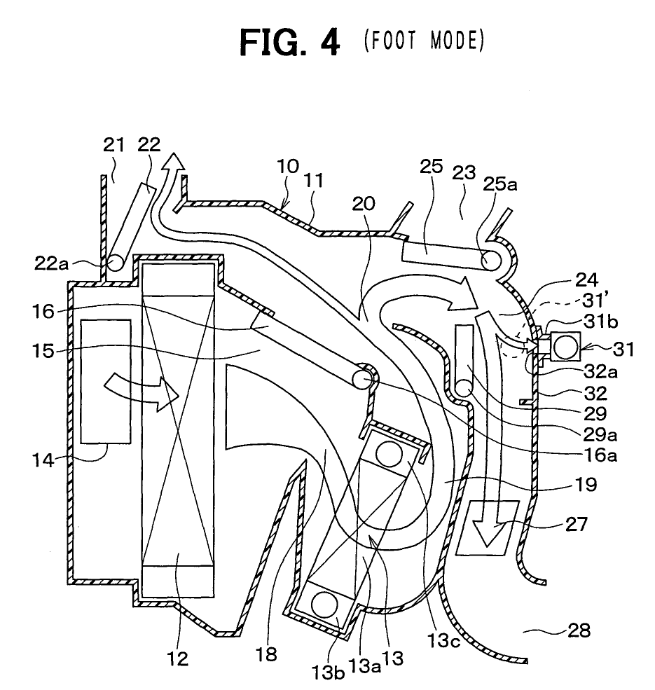

FIG. 4 shows the air-conditioner in which the air-mixing door 16 is positioned at the maximum heating position, and the foot mode is selected. The air-mixing door 16 fully closes the bypass passage 15 and fully opens the inlet passage 18 to the heater core 13. Under the foot mode, the face opening 23 is fully closed by the face-foot switching door 25, and the foot duct 24 led to the foot openings 27, 28 is fully opened by the foot door 29. The defroster opening 21 is partially opened by the defroster door 22.

Air heated by the heater core 13 flows through the hot air duct 19 and reaches the air-mixing space 20. Then, a most portion of the hot air flows into the foot duct 24 and is supplied to the foot portion of the passengers from the foot ducts 27, 28. A portion of the hot air flowing through the foot duct 24 enters into the aspirator 31 through its air-introducing port 32a, thereby drawing the air in the passenger compartment to the sensor element 33b in the temperature sensor 33. Also, a portion of the hot air flows through the partially opened defroster opening 21 and is supplied to the windshield.

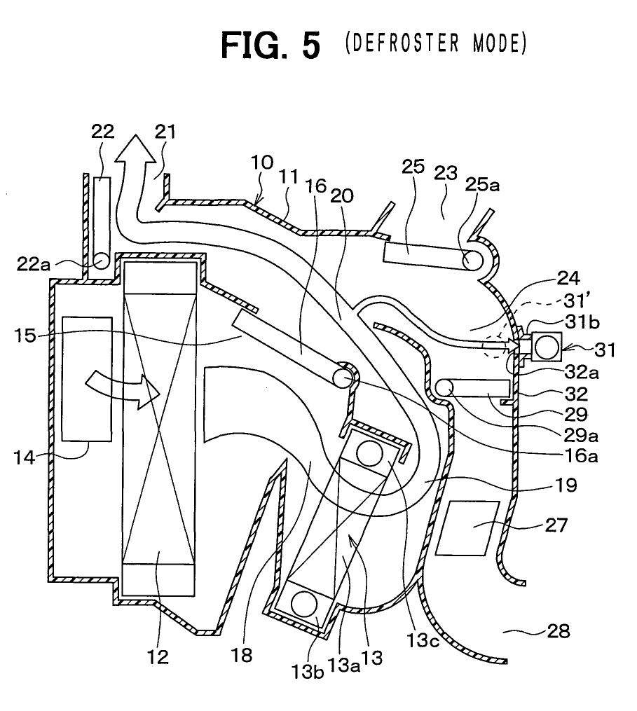

FIG. 5 shows the air-conditioner in which the air-mixing door 16 is positioned at the maximum heating position, and the defroster mode is selected. Under the defroster mode, the face opening 23 is fully closed and the inlet to the foot duct 24 is fully opened by the face-foot switching door 25. The foot duct 24 led to the foot openings 27, 28 are fully closed by the foot door 29. The defroster opening 21 is fully opened by the defroster door 22.

A most portion of the air heated by the heater core 13 flows through the hot air duct 19 and the air-mixing space 20, and then flows out of the fully opened defroster opening 21. The hot air flowing out of the defroster opening 21 is blown to the windshield. A portion of the hot air branches out at the air-mixing space 20 and flows into the aspirator 31 through the foot duct 24 to thereby draw the air in the passenger compartment to the temperature sensor 33.

The air-conditioner can be operated also under a bilevel mode, in which the face-foot switching door 25 partially opens both the face opening 23 and the foot duct 24, and the foot duct led to the foot openings 27, 28 are fully opened by the foot door 29. Under the bilevel mode, conditioned air is blown out of both the face opening 23 and the foot openings 27, 28. Further, the air-conditioner can be operated under a foot-defroster mode, in which the opening degree of the defroster door 22 shown in FIG. 4 (foot mode) is increased. Under the foot-defroster mode, hot air is supplied from both the foot openings 27, 28 and the defroster opening 21. Under the bilevel mode and the foot-defroster mode, a portion of the air flowing through the foot duct 24 is supplied to the aspirator 31, and thereby the air in the passenger compartment is drawn to the sensor element 33b in the temperature sensor 33.

Under all the operating modes, a portion of the air flowing through the foot duct 24 is supplied to the aspirator 31 mounted on the rear wall 32, as explained above. Therefore, the air in the passenger compartment can be always drawn into the temperature sensor 33. Since the sidewalls of the casing 11 that extend in the front to rear direction of the vehicle are exposed to the foot duct 24 through which the conditioned air always flows, it is possible to mount the aspirator 31 on one of the sidewalls at a rear side portion thereof. The possible mounting position of the aspirator 31 on the sidewall is shown with a dotted line and a reference number 31′ in FIGS. 1 and 3-5.

Advantages obtained in the first embodiment described above will be summarized as below. In the center-positioned air-conditioner unit 10, the aspirator 31 can be mounted on the rear wall 32 or one of the sidewalls. In other words, a freedom in selecting the positions for mounting the aspirator 31 is enhanced according to the present invention. Since the aspirator 31 is mounted apart from the temperature control mechanism 17 and the mode control mechanism, both being mounted on the sidewall as shown in FIG. 1, the aspirator 31 does not interfere with those mechanisms.

Since the air blown out of the outlet 31f of the aspirator 31 does not directly hit the servomotors 17a, 30a, it is avoided that moisture condenses inside the servomotors 17a, 30a due to the cool air blown out of the aspirator 31. Further, since the conditioned air is blown out of the aspirator 31, it does not disturb or adversely affect the conditioned atmosphere in the passenger compartment.

(Second Embodiment)

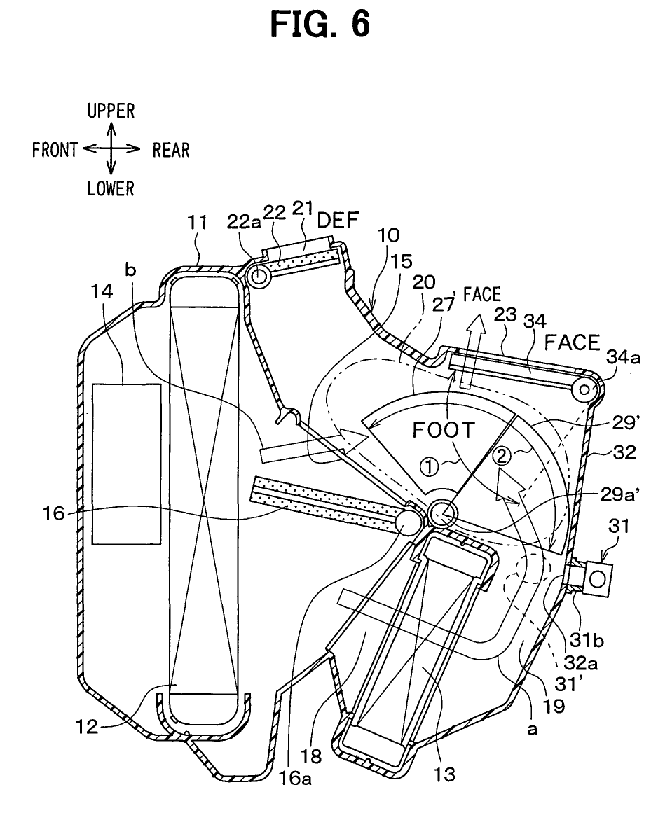

A second embodiment of the present invention will be described with reference to FIGS. 6-11. In this second embodiment, the foot duct 24 in the first embodiment is eliminated, and a foot opening 27′ which is directly open to the air-mixing space 20 is formed on the sidewall of the casing 11, as shown in FIG. 6. The aspirator 31 is mounted on the rear wall 32 as in the first embodiment. The aspirator 31 may be mounted on the sidewall at the position shown with dotted line and a reference number 31′. Other structures are similar to those of the first embodiment. The same reference numbers denote the same parts or components as in the first embodiment.

In this second embodiment, the hot air duct 19 is disposed between the heater core 13 and the rear wall 32. The air-mixing space 20 is formed in the casing 11 above the bypass passage 15 and the hot air duct 19. The air-mixing space 20 is formed in an oval region shown with a chained line in FIG. 6. The face opening 23 is positioned at an upper rear portion of the casing 11, and a face door 34 for opening or closing the face opening 23 is supported by a rotatable shaft 34a.

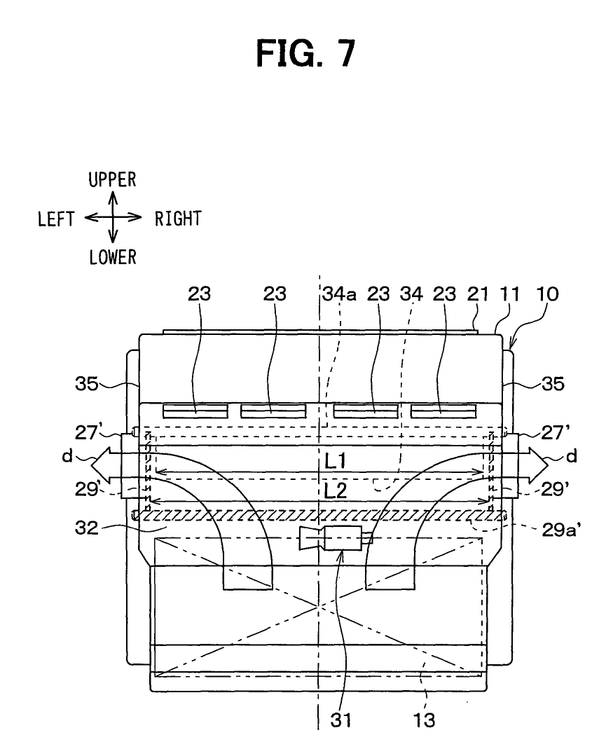

The face door 34 is a flat plate elongated in the right-to-left direction of the vehicle, as shown in FIG. 7 showing the air-conditioner unit 10 viewed from the passenger compartment. The face door 34 is connected to the shaft 34a that is rotatably supported on both sidewalls 35. The foot opening 27′ is formed on each sidewall 35 in a region corresponding to the air-mixing space 20. The foot opening 27′ is sector-shaped and is opened or closed by a foot door 29′ which is also sector-shaped. The foot door 29′ is fixed to a rotatable shaft 29a′ and is driven to slide on the inner surface of the sidewall 35.

The face door 34 is driven in an angular range \mathring{1} while the foot door 29′ is driven in an angular range \mathring{2} as shown in FIG. 6. The lateral width L1 of the face door 34 is made a little smaller than an inner distance L2 between both foot doors 29′, as shown in FIG. 7, so that the face door 34 and the foot doors 29′ can freely rotate without interfering with each other. The face door 34, the defroster door 22 and the foot doors 29′ are doors for setting the operating modes and are controlled by the mode control mechanism 30 (shown in FIG. 1) that is mounted on the outer surface of the sidewall 35.

The aspirator 31 is mounted on the rear wall 32, as shown in FIG. 6, in the similar manner as in the first embodiment. The air-introducing port 32a of the aspirator 31 is open to the hot air duct 19 to introduce the air flowing through the hot air duct 19 into the aspirator 31.

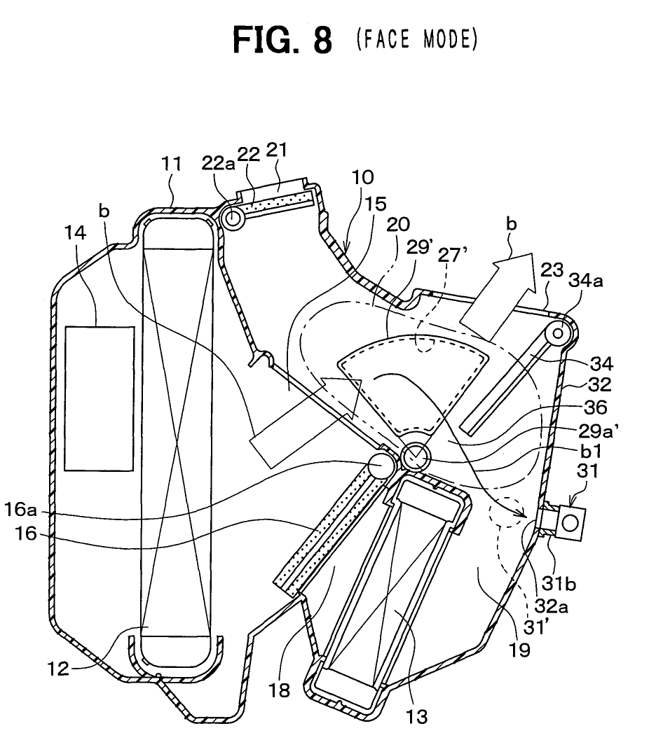

Now, operation of the second embodiment will be described with reference to FIGS. 8-11 showing the face mode, the bilevel mode, the foot mode and the defroster mode, respectively. Under the face mode shown in FIG. 8, the face opening 23 is fully opened by the face door 34, and a communication passage 36 communicating between the air-mixing space 20 and the hot air duct 19 is formed. At the same time, the defroster opening 21 is fully closed by the defroster door 22, and the foot opening 27′ is fully closed by the foot door 29′.

When the air-mixing door 16 is brought to the maximum cooling position, i. e., the position to fully open the bypass passage 15 and to fully close the inlet passage 18 to the heater core 13 as shown in FIG. 8, a most portion of the cool air “b” flowing through the evaporator 12 and the bypass passage 15 is led to the fully opened face opening 23 and blown out therethrough. A portion of the cool air “b1” flowing through the air-mixing space 20 and the communication passage 36 is supplied to the aspirator 31. By controlling the air-mixing door 16 to an intermediate position to partially open both the inlet passage 18 and the bypass passage 15, the cool air mixed with the hot air is blown out of the face opening 23.

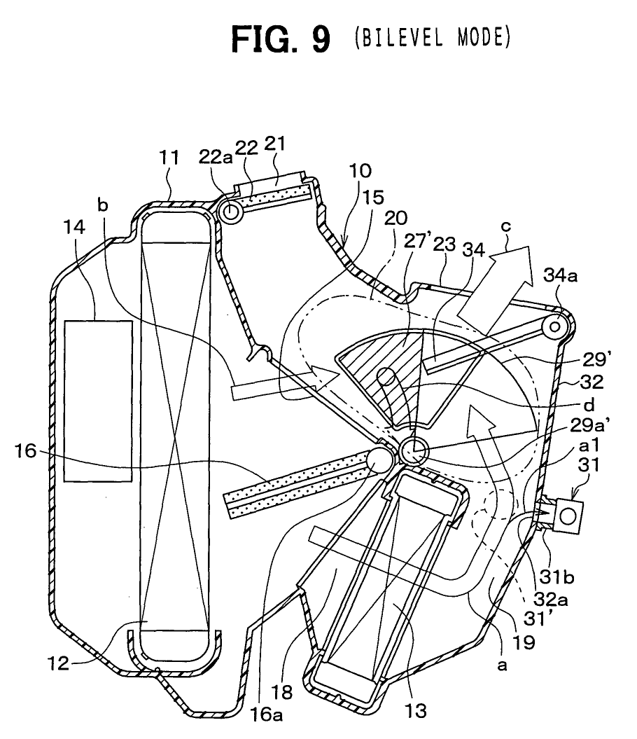

Under the bilevel mode shown in FIG. 9, the defroster opening 21 is fully closed by the defroster door 22. The face opening 23 is half opened by the face door 34, and the foot opening 27′ is also half opened by the foot door 29′. The hatched area of the foot opening 27′ in FIG. 9 is the open area of the foot opening 27′. The air-mixing door 16 is controlled to its intermediate position. The hot air “a” and the cool air “b” are mixed in the air-mixing area 20, and the mixed air (conditioned air) is blown toward the face opening 23 and the foot opening 27′, both half opened. The conditioned air is blown out of the face opening 23 as shown by an arrow “c” and out of the foot opening 27′ as shown by an arrow “d”. A portion “a1” of the hot air “a” is fed to the aspirator 31 through its air-introducing port 32a.

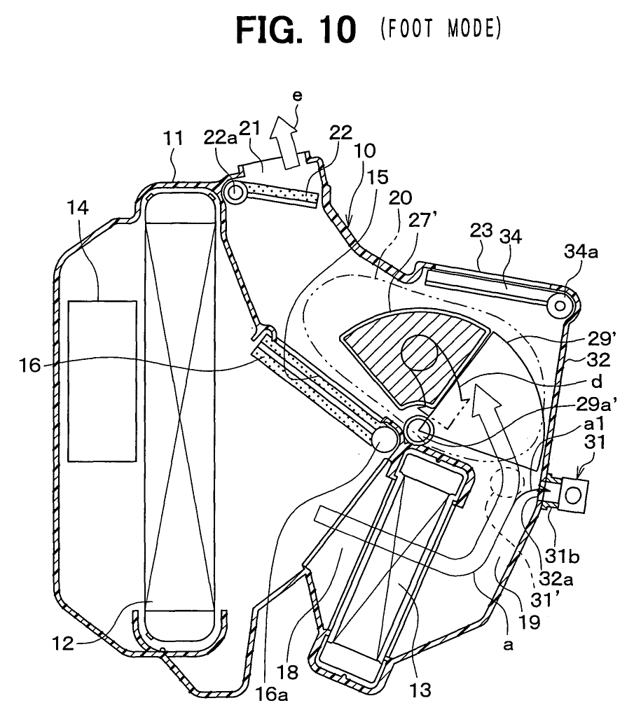

Under the foot mode shown in FIG. 10, the defroster opening 22 is partially opened by the defroster door 21. The face opening 23 is fully closed by the face door 34, while the foot opening 27′ is fully opened. In FIG. 10, the bypass passage 15 is fully closed by the air-mixing door 16 and the inlet passage 18 to the heater core 13 is fully opened. The air passing through the evaporator 12 is all sent to the heater core 13, and the heated air “a” flows through the hot air duct 19. A most portion of the hot air is blown out of the foot openings 27′ formed on both sidewalls 35 and supplied to the foot portion of the passengers. A portion of the hot air is blown out of the partially opened defroster opening 21 and supplied to the windshield. A portion “a1” of the hot air “a” flowing through the hot air duct 19 is fed to the aspirator 31.

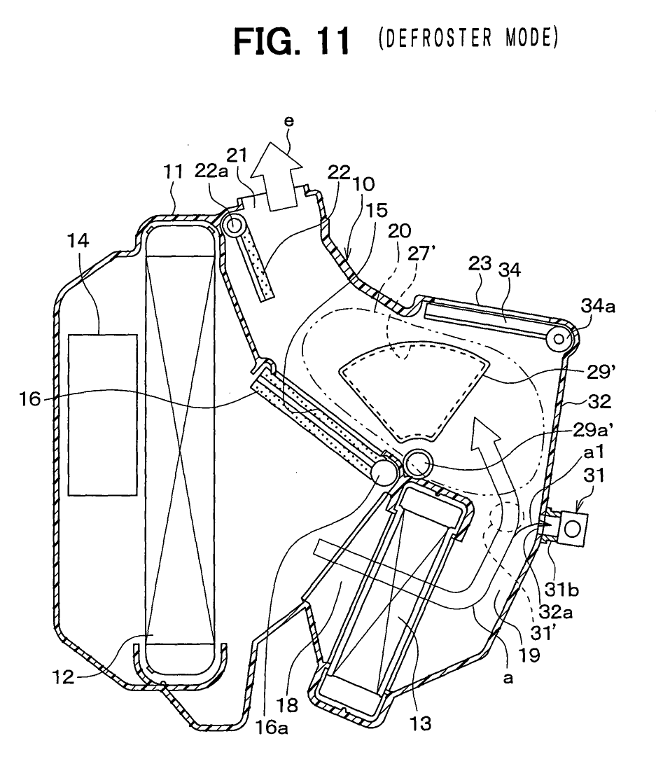

Under the defroster mode shown in FIG. 11, the defroster opening 21 is fully opened. The face opening 23 is fully closed by the face door 34, and the foot opening 27′ is fully closed by the foot door 29′. In FIG. 11, the bypass passage 15 is fully closed by the air-mixing door 16, while the inlet opening 18 to the heater core 13 is fully closed. All the air passing through the evaporator 12 is supplied to the heater core 13 and heated therein, forming the hot air “a” flowing through the hot air duct 19. A most portion of the hot air flows through the air-mixing area 20 and is blown out of the fully open defroster opening 21 as a hot air stream “e”. The hot air is supplied to the windshield to thereby defrost the windshield. A portion “a1” of the hot air “a” flowing through the hot air duct 19 is fed to the aspirator 31 through its air-introducing port 32a.

Under all of the operating modes, i.e., the face mode, the bilevel mode, the foot mode and the defroster mode, a portion of the conditioned air is always supplied to the aspirator 31 mounted on the rear wall 32. Therefore, the aspirator 31 functions to draw the air in the passenger compartment to the temperature sensor 33. The aspirator 31 may be mounted on either one of the sidewalls 35, instead of the rear wall 32, at a place exemplified by dotted line 31′ in FIGS. 6 and 8-11. In addition to the four operating modes described above, a foot-defroster mode, under which the hot air is equally blown out from both the foot opening 27′ and the defroster opening 21, may be provided.

Since the foot opening 27′ is formed on the sidewall 35 in the air-mixing space 20 in the second embodiment, the hot air “a” and the cool air “b” can be directly supplied to the foot opening 27′. Therefore, the foot duct 24 that is provided in the first embodiment to make a U-turn from the hot air duct 19 is not required in the second embodiment. Therefore, pressure loss in the U-turn passage can be eliminated in the second embodiment, and an amount of air blown out under the foot mode is increased while reducing airflow noises. Since the foot opening 27′ is opened or closed by the foot door 29′ that slidably moves along an inner surface of the sidewall 35, almost no space for operating the foot door 27′ is required in the second embodiment. Accordingly, the air-conditioner unit 10 can be made compact in size. In this second embodiment, too, the aspirator 31 can be positioned in the air-conditioner casing 11 with a greater freedom.

(Third Embodiment)

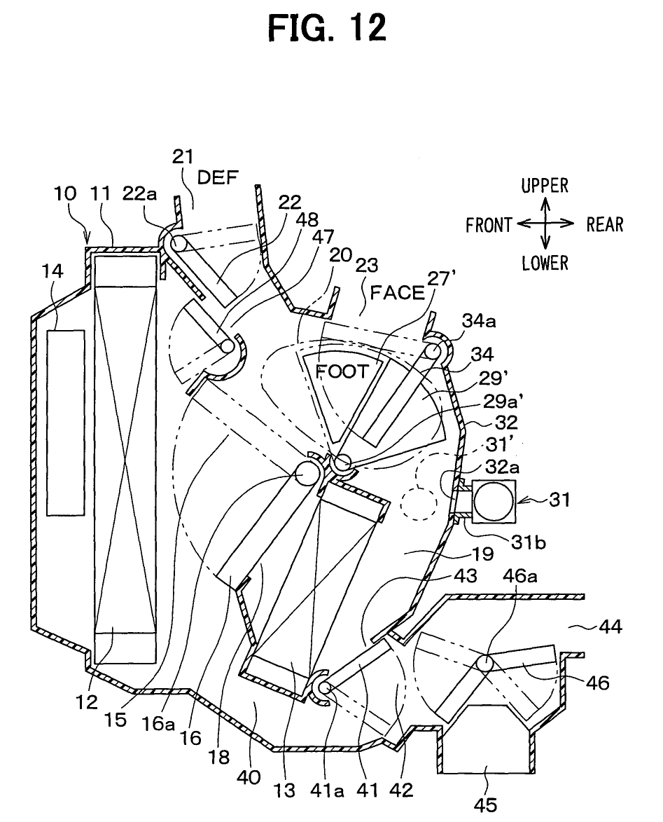

The second embodiment described above is further modified to a form shown in FIG. 12 as a third embodiment of the present invention. In this third embodiment, temperatures of the conditioned air supplied to the front seats and the rear seats are controlled independently from each other.

For this purpose, a bypass passage 40 for the rear seats is disposed in the casing 11 at a position under the heater core 13. The bypass passage 40 is opened or closed by an air-mixing door 41 for the rear seats. The air-mixing door 41 is fixed to a shaft 41a that is rotatably supported on the sidewalls of the casing 11. An air-mixing space 42 for the rear seats is provided downstream of the air-mixing door 41. A hot air inlet 43 for the rear seats is open to the air-mixing space 42 at a bottom portion of the hot air duct 19.

An amount of the hot air and that of the cool air mixed in the air-mixing space 42 are controlled by changing an opening degree of the air mixing door 41. The temperature of the conditioned air supplied to the rear seats is controlled independently from the temperature of the conditioned air supplied to the front seats. The bypass passage 15 and the air-mixing door 16 are solely for the front seats in this embodiment. The air-mixing space 42 is branched out to a face opening 44 for the rear seats and a foot opening 45 for the rear seats. The face opening 44 and the foot opening 45 are selectively opened or closed by a mode-switching door 46 for the rear seats. The mode-switching door 46 is an angled plate as shown in FIG. 12 and is fixed to a shaft 46a that is rotatably supported on the sidewalls of the casing 11. By controlling the positions of the mode-switching door 46, the operating modes for the rear seats are switched to one of desired modes, i.e., the face mode, the bilevel mode or the foot mode.

A cool air bypass passage 47 and a bypass door 48 are also provided in this third embodiment. The cool air bypass passage 47 is formed downstream of an upper portion of the evaporator 12. The cool air bypass passage 47 is opened or closed by the bypass door 48. Under the bilevel mode, the cool air bypass passage 47 is opened so that the cool air passing through the evaporator 12 flows through the cool air bypass passage 47 and directly enters into the face opening 23. In this manner, the temperature of the conditioned air blown out of the face opening 23 can be made lower than the temperature of the conditioned air blown out of the foot opening 27′. Thus, a so-called “cool-head and warm-foot” condition is realized under the bilevel mode. Also, it is possible to open the cool air bypass passage 47 when the air-mixing door 16 is controlled to the maximum cooling position, so that the cooling effects of the air-conditioner are further enhanced.

The aspirator 31 is mounted on the rear wall 32 in this third embodiment, too. Alternatively, the aspirator 31 may be mounted on the sidewall 35 at the position shown with a dotted line 31′. Air is always introduced into the aspirator 31 under any mode operation.

The present invention is not limited to the embodiments described above, but it may be variously modified. For example, though the temperature control mechanism 17 and the mode-control mechanism 30 are driven by the servomotors 17a and 30a, respectively, in the foregoing embodiments, those mechanisms may be manually operated by a driver or a passenger. Though the aspirator 31 is mounted on the rear wall 32 to be exposed to the hot air duct 19 in the second and the third embodiments, it may be mounted on the rear wall 32 at its upper portion to communicating with the air-mixing space 20.

While the present invention has been shown and described with reference to the foregoing preferred embodiments, it will be apparent to those skilled in the art that changes in form and detail may be made therein without departing from the scope of the invention as defined in the appended claims.

What is claimed is:

1. An air-conditioner for an automotive vehicle, the air-conditioner comprising:
air-conditioner casing, disposed substantially along a center line of the vehicle, into which air is introduced from a front side of the vehicle;
an evaporator contained in the casing for cooling the air introduced into the casing;
a heater core contained in the casing for heating the air after the air is cooled by the evaporator;
a bypass passage formed in the casing for leading the air from the evaporator, bypassing the heater core;
an air-mixing door contained in the casing for controlling a ratio of an amount of hot air passing through the heater core relative to an amount of cool air passing through the bypass passage;
an air-mixing space formed in the casing for mixing the hot air and the cool air;
a foot duct, formed in the casing, into which the air mixed in the air-mixing space flows;
a foot opening for blowing out the air supplied through the foot duct to a lower portion of a passenger;
a foot door for selectively opening or closing the foot opening;
a face opening for blowing out the air supplied from the air-mixing space to an upper portion of a passenger;
a face-foot switching door for switching an airflow between the foot duct and the face opening;
a temperature sensor for sensing temperature in a passenger compartment;
an aspirator for drawing air in the passenger compartment to the temperature sensor, wherein:
the foot opening and the foot duct are disposed behind the air-mixing space at a rear side of the casing;
an air-introducing port of the aspirator is open to the foot duct at a position between the face-foot switching door and the foot door; and
when the face-foot switching door is brought to a position to fully open the face opening, the foot duct is not completely closed by the face-foot switching door but a small opening is left open in the foot duct while the foot opening is fully closed by the foot door.

2. The air-conditioner as in claim 1, wherein:
the aspirator is mounted on a rear wall of the casing, the rear wall extending in a right-to-left direction of the vehicle.

3. The air-conditioner as in claim 1, wherein:
the aspirator is mounted on a sidewall of the casing at a position between the face-foot switching door and the foot door, the sidewall extending in a front-to-rear direction of the vehicle.

4. An air-conditioner for an automotive vehicle, the air-conditioner comprising:
air-conditioner casing, disposed substantially along a center line of the vehicle, into which air is introduced from a front side of the vehicle;
an evaporator contained in the casing for cooling the air introduced into the casing;
a heater core contained in the casing for heating the air after the air is cooled by the evaporator;
a bypass passage formed in the casing for leading the air from the evaporator, bypassing the heater core;
an air-mixing door contained in the casing for controlling a ratio of an amount of hot air passing through the heater core to an amount of cool air passing through the bypass passage;
an air-mixing space formed in the casing for mixing the hot air and the cool air;
a foot opening formed on a sidewall of the casing, the sidewall extending in a front-to-rear direction of the vehicle, the foot opening blowing out air passing through the air-mixing space to a foot portion of a passenger;
a foot door for selectively opening or closing the foot opening;
a face opening for blowing out the air supplied from the air-mixing space to an upper portion of a passenger;
a face door for opening or closing the face opening;
a temperature sensor for sensing temperature in a passenger compartment;
an aspirator for drawing air in the passenger compartment to the temperature sensor, wherein:
air passing through the heater core flows through a hot air duct that is formed in a space between the heater core and a rear wall of the casing;
an air-introducing port of the aspirator is open to the hot air duct or to a space above the hot air duct; and
the hot air duct is always communicating with the air-mixing space irrespective of opening or closing positions of the face door and the foot door.

5. The air-conditioner as in claim 4, wherein:
the face opening is disposed at an upper-rear portion of the casing; and
a communication passage communicating between the air-mixing space and the hot air duct is formed when the face door opens the face opening.

6. The air-conditioner as in claim 4, wherein:
the foot door is driven to open or close the foot opening, sliding on an inside surface of the sidewall.

7. The air-conditioner as in claim 4, wherein:
the aspirator is mounted on the rear wall of the casing.

8. The air-conditioner as in claim 4, wherein:
the aspirator is mounted on the sidewall of the casing at a position communicating with the hot air duct or an upper space above the hot air duct.
